(19) United States
(12) Patent Application Publication
(10) Pub. No.: US 2013/0280147 A1
(43) Pub. Date: Oct. 24, 2013

(54) AIRTIGHT CONTAINER FOR EXPERIMENTS

(71) Applicant: Do Won KANG, Seoul (KR)

(72) Inventor: Do Won KANG, Seoul (KR)

(21) Appl. No.: 13/454,168

(22) Filed: Apr. 24, 2012

(51) Int. Cl. B01L 3/00

(52) U.S. Cl. 422/547

(57) ABSTRACT

An airtight container for a reaction experiment, includes a reaction container made of Teflon, the reaction container having an opening in at least a portion thereof; and a casing configured to support and enclose a circumferential outer surface of the reaction container. Further, the airtight container for the reaction experiment includes a Teflon film configured to close the opening of the reaction container; and a pressing part configured to bring the Teflon film into close contact with the reaction container. Furthermore, the airtight container for the reaction experiment includes a cover configured to apply a force to the pressing part so that the Teflon film is kept in close contact with the reaction container.

### FIELD OF THE INVENTION

The present invention relates to an airtight container for experiments.

### BACKGROUND OF THE INVENTION

In laboratories, a variety of experiments involving chemical reactions are carried out. For example, an experiment may be to put different kinds of samples into an airtight container and have the samples participate in a chemical reaction.

Among experiments using airtight containers, some experiments require experimenters to observe the status of samples that are being involved in reactions with the naked eye. In such experiments, experiment containers are typically used.

However, depending on the kind of sample, an experiment container made of glass may not be able to be used. For example, if hydrofluoric (HF) acid is used in a chemical reaction, a glass experiment container cannot be used, because the hydrofluoric acid may dissolve the container. In this case, an opaque airtight container made of a material that can withstand the hydrofluoric acid needs to be used, and the experimenter is not allowed to observe the status of the sample which is involved in the chemical reaction. Thus, the experimenter cannot check the status of the sample until the airtight container is opened after the reaction has finished and the container has been cooled and pressure thereof has been controlled.

Particularly, if the sample is very expensive metal, a great loss may be incurred in terms of the cost of the experiment.

### SUMMARY OF THE INVENTION

In view of the above, the present invention provides an airtight container for experiments which allows an experimenter to observe the status of a sample that is participating in a chemical reaction.

In accordance with an embodiment of the present invention, there is provided an airtight container for a reaction experiment, including: a reaction container made of Teflon, the reaction container having an opening in at least a portion thereof; a casing configured to support and enclose a circumferential outer surface of the reaction container; a Teflon film configured to close the opening of the reaction container; a pressing part configured to bring the Teflon film into close contact with the reaction container; and a cover configured to apply a force to the pressing part so that the Teflon film is kept in close contact with the reaction container, wherein at least one of the Teflon film and the reaction container is transparent, wherein in a case where the Teflon film is transparent, the pressing part is made of a transparent material, and in a case where the reaction container is transparent, the casing is made of a transparent material.

Further, the holes may be respectively formed in the pressing part and the cover so that when the Teflon film is torn, gas is discharged out of the reaction container through the holes.

The Teflon film may include a transparent Teflon film, and the pressing part is made of one of glass, quartz and Pyrex.

Further, a hole may be formed in the cover at a position corresponding to the pressing part and the Teflon film.

The pressing part may be brought into close contact with the Teflon film by a lid supported by the casing, and the lid may be brought into close contact with the casing by the cover.

Further, the reaction container may be made of a transparent Teflon film, and the casing may be made of one of glass, quartz and Pyrex.

The cover may be threadedly coupled to the casing.

Furthermore, the pressing part may have a shape of a convex lens.

As described above, in an airtight container for experiments in accordance with the present invention, at least one side of the container is made of a transparent Teflon film so that an experimenter can observe the status of a sample that is participating in a chemical reaction.

Further, a cover made of transparent material supports the transparent Teflon film so that the airtight container can withstand a predetermined degree of pressure.

Furthermore, a pressure relief hole is formed in the cover. Therefore, even if the pressure in the container abnormally increases, the experiment can be safely carried out.

### BRIEF DESCRIPTION OF THE DRAWINGS

The objects and features of the present invention will become apparent from the following description of embodiments given in conjunction with the accompanying drawings, in which:

FIG. 1 is a front view of an airtight container for experiments, in accordance with a first embodiment of the present invention;

FIG. 2 is a plan view of the airtight container in accordance with the first embodiment of the present invention;

FIG. 3 is an exploded perspective view of the airtight container in accordance with the first embodiment of the present invention;

FIG. 4 is a cross sectional view taken along the line IV-IV′ of FIG. 3;

FIGS. 5A and 5B are perspective views showing an experimental instrument provided with an airtight container in accordance with a second embodiment of the present invention, and an example diagram which a plurality of experimental instruments are connected each other into a single body, respectively;

FIG. 6 is an exploded perspective view of FIG. 5A; and

FIG. 7 is a cross sectional view taken along the line VII-VII′ of FIG. 6.

### DETAILED DESCRIPTION OF THE EMBODIMENTS

Hereinafter, embodiments of the present invention will be described in detail with reference to the accompanying drawings which form a part hereof.

If in the specification, detailed descriptions of well-known functions or configurations would unnecessarily obfuscate the gist of the present invention, the detailed descriptions will be omitted.

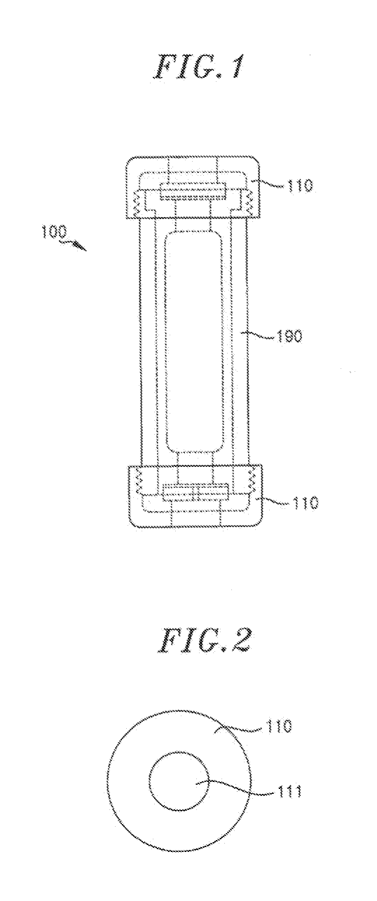

FIG. 1 is a front view of an airtight container for experiments, in accordance with a first embodiment of the present invention, and FIG. 2 is a plan view of the airtight container in accordance with the first embodiment of the present invention.

Referring to FIGS. 1 and 2, the airtight container 100 in accordance with the first embodiment of the present invention includes a casing 190 which is open on upper and lower ends thereof, and covers 110 which close the openings of the casing 190.

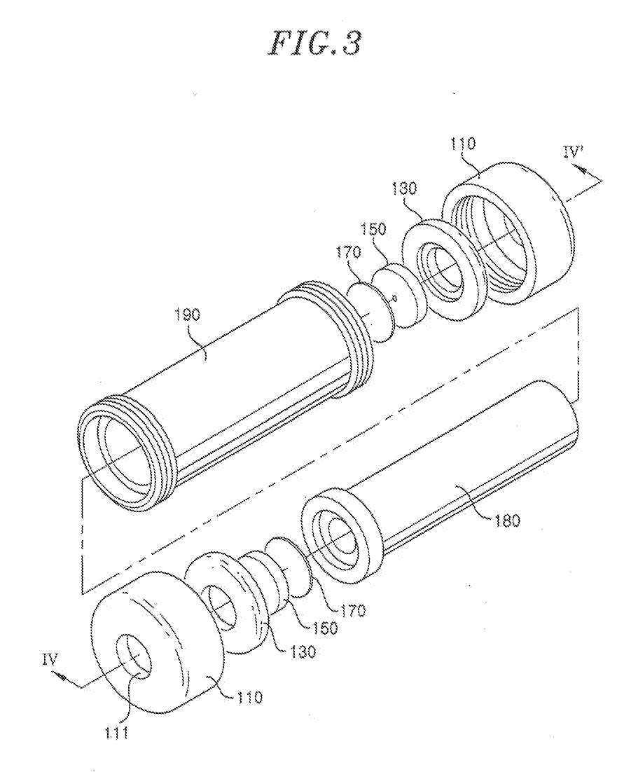

The casing 190 or at least one of the covers 110 may be partially transparent or have a hole therein to allow an experimenter to observe, with the naked eye, the status of a sample that is participating in a chemical reaction or being heated in a reaction container 180 shown in FIG. 3 disposed in the casing 190. Transparent Teflon is used as the material of a portion of the reaction container 180 that corresponds to the transparent portion or the portion with the hole of the casing 190 or the cover 110.

In this embodiment, as one example, a sample preprocessing operation will be explained, in which a sample is put into the reaction container 180 of the airtight container 100 and then the airtight container 100 is heated by a microwave oven or a typical heating box.

Further, in this embodiment, a structure in which an observation hole 111 is formed in the cover 110, allowing the experimenter to observe the inside of the reaction container 180, will be described. That is, in this embodiment, the experimenter can use the observation hole 111 of the airtight container 100 to observe the inside of the reaction container 180 when the airtight container 100 is being heated or the heating has temporarily paused.

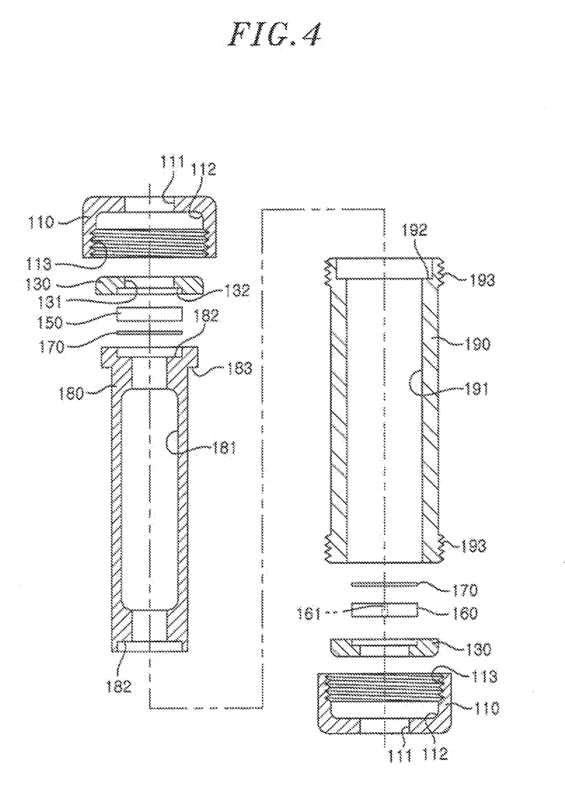

FIG. 3 is an exploded perspective view of the airtight container in accordance with the first embodiment of the present invention, and FIG. 4 is a cross sectional view taken along the line IV-IV′ of FIG. 3.

Referring to FIGS. 3 and 4, the airtight container 100 includes the reaction container 180, transparent Teflon films 170, pressing plates 150 and 160, lids 130, the casing 190 and the covers 110. The sample is input into the reaction container 180. The transparent Teflon films 170 close the respective opposite open ends of the reaction container 180. The pressing plates 150 and 160 are made of transparent material and bring the corresponding Teflon films 170 into close contact with the reaction container 180. The lids 130 bring the corresponding pressing plates 150 and 160 into close contact with the reaction container 180. The casing 190 encloses and supports the reaction container 180. The covers 110 press the corresponding lids 130 and are coupled to the casing 190.

The reaction container 180 includes a space 181 in which the input sample participates in the reaction, such as a chemical reaction, a thermal reaction, and the like. The opposite ends of the space 181 that face each other are open. In this embodiment, the case where the upper and lower ends of the space 181 are open will be exemplified.

The shape of the reaction container 180 is cylindrical. A flange 183 protrudes a predetermined length from the periphery of the upper end of the reaction container 180. The flange 183 is stopped by a seating portion 192 of the casing 190 that will be explained later. Accordingly, the reaction container 180 is fixed to the casing 190.

A film seating portion 182 is formed in each of the upper and lower ends of the space 181 of the reaction container 180 so that each transparent Teflon film 170 is seated into the corresponding film seating portion 182. The film seating portion 182 may be a recess that is stepped to a predetermined depth from the surface of the reaction container 180.

The reaction container 180 is preferably made of Teflon so that it can be used even in experiments in which a sample is strong acid, such as nitric acid, hydrochloric acid, sulfuric acid, hydrofluoric acid, phosphoric acid, and the like. The reaction container 180 may be opaque.

Each transparent Teflon film 170 is a transparent film and has a shape corresponding to that of the associated film seating portion 182. The transparent Teflon films 170 are put into close contact with the corresponding film seating portions 182 that are formed in the upper and lower ends of the reaction container 180, thus closing the upper and lower openings of the space 181. Consequently, the sample input into the reaction container 180 can be prevented from leaking out of the reaction container 180 while it is participating in a reaction taking place in the reaction container 180.

The transparent Teflon films 170 are kept in close contact with the reaction container 180 by the pressing plate 150 and 160. The shape of each pressing plate 150, 160 corresponds to that of the associated film seating portion 182, and the material thereof may be transparent glass, quartz, Pyrex, and the like. Therefore, the experimenter can observe the sample in the reaction container 180 through the pressing plate 150 or 160 and the corresponding transparent Teflon film 170.

Both or one of the pressing plates 150 and 160, for example, the pressing plate 160, has a pressure relief hole 161 which is provided to cope with an abnormal pressure increase in the reaction container 180. The pressure relief hole 161 is formed at a position corresponding to the space 181 of the reaction container 180 and allows the transparent Teflon film 170 to be torn when the pressure in the space 181 excessively increases, thus allowing gas to be discharged out of the pressure relief hole 161. Changing the diameter of the pressure relief hole 161 is allowed so that the pressure at which the transparent Teflon film 170 is torn can be adjusted. In this embodiment, the case where the pressure relief hole 161 is formed in the pressing plate 160 provided in the lower end of the reaction container 180 is illustrated.

A portion of each pressing plate 150, 160 is fitted into the corresponding film seating portion 182 formed in the reaction container 180, and the other portion thereof protrudes outwards from the reaction container 180. The protruded portion of the pressing plate 150, 160 is inserted into the corresponding lid 130.

The shape of each pressing plate 150, 160 may be that of a convex lens. In this case, the experimenter can see a magnified image of the inside of the reaction container 180 and thus more easily observe a reaction in the reaction container 180.

Each pressing plate 150, 160 may be called a pressing part, because it functions to bring the corresponding transparent Teflon film 170 into contact with the reaction container 180.

The lids 130 are respectively coupled to the upper and lower ends of the reaction container 180. Each lid 130 presses the protruded portion of the corresponding pressing plate 150, 160, thus bringing the pressing plate 150, 160 into contact with the reaction container 180. A pressing plate seating portion 132 is depressed in each lid 130 to a predetermined depth into a shape corresponding to that of the protruded portion of the associated pressing plate 150, 160 so that the pressing plate 150, 160 can be put into close contact with the pressing plate seating portion 132. The sum of the depth of the pressing plate seating portion 132 and the depth of the film seating portion 182 corresponds to the sum of the thickness of the transparent Teflon film 170 and the thickness of the pressing plate 150, 160.

A lid hole 131 is vertically formed through each lid 130 at a position corresponding to approximately the central portions of the space 181, the corresponding transparent Teflon film 170 and the corresponding pressing plate 150, 160. That is, the experimenter can observe the inside of the reaction container 180 through the lid hole 131.

The diameter of each lid 130 is greater than the outer diameter of the reaction container 180 and less than the outer diameter of the casing 190 so that the lid 130 can be placed on the casing 190.

Each lid 130 is put into close contact with the casing 190 by the corresponding cover 110. In other words, as the cover 110 applies force to the lid 130, the force is applied to the corresponding pressing plate 150, 160, whereby the close contact between the transparent Teflon film 170 and the reaction container 180 can be maintained.

Each cover 110 includes a lid seating portion 112 which is depressed to allow the lid 130 to be seated therein, an internal thread 113 which is formed at an opening side of the lid seating portion 112 and engages with an external thread 193 of the casing 190 that will be explained later herein, and the observation hole 111 which is formed at a position corresponding to that of the lid hole 131.

The shape of the lid seating portion 112 corresponds to that of the lid 130 and is that of a recess that is depressed to a depth appropriate to put the lid 130 into close contact with the lid seating portion 112 when the cover 110 is threaded over the casing 190.

The internal thread 113 is formed such that the length and shape thereof correspond to those of the external thread 193 which will be explained later herein. The internal thread 113 extends to the open end of the lid seating portion 112.

The observation hole 111 is formed in an approximately central portion of the lid seating portion 112 at a position corresponding to that of the lid hole 131. Thereby, the experimenter can observe the status of the inside of the space 181 through the transparent Teflon film 170, the pressing plate 150 or 160, the lid hole 131 and the observation hole 111.

The casing 190 has a reaction container hole 191, the flange seating portion 192 and the external threads 193. The reaction container hole 191 is vertically formed through the casing 190 so that the reaction container 180 may be inserted into the hole 191. The flange seating portion 192 is formed in the upper end of the hole 191, and the flange 183 of the reaction container 180 is placed onto the flange seating portion 192. The external threads 193 are formed on the respective outer circumferences of the upper and lower ends of the casing 190, and the covers 110 are threaded over the respective external threads 193.

The thicknesses of the lids 110, the pressing plates 150 and 160 and the transparent Teflon films 170 and the reaction container 180, and the depths of the lid seating portions 112, the pressing plate seating portions 132 and the film seating portions 182 can be adjusted so that the lids 110, the pressing plates 150 and 160, the transparent Teflon films 170 and the reaction container 180 can be brought into close contact with each other by the threaded-coupling of the covers 110 to the casing 190.

The length of the casing 190 corresponds to that of the reaction container 180 so that when the flange 183 is placed on the seating portion 192, the top and bottom of the reaction container 180 are respectively level with the top and bottom of the casing 190.

The diameter of the reaction container hole 191 corresponds to the outer diameter of the reaction container 180, thus preventing the reaction container 180 inserted in the reaction container hole 191 from moving with respect to the casing 190.

The materials of the covers 110, the lids 130 and the casing 190 may be changed depending on the purpose, conditions, and the like of the experiment. For instance, if the airtight container 100 is used in a microwave oven, they are made of a material, such as Teflon, ceramic, Ultem, polyetheretherketone (PEEK), polyphenylene sulfide (PPS), and the like, which does not absorb microwaves. If the airtight container 100 is used in a typical oven, a heater, a hot block, and the like, they are made of metal, ceramic, Pyrex, quartz, and the like.

The order in which the airtight container 100 having the above-mentioned construction is assembled will now be described.

First, the reaction container 180 is inserted into the hole 191 of the casing 190 such that the flange 183 is on the flange seating portion 192. The transparent Teflon films 170 are thereafter inserted into the corresponding film seating portions 182 which are formed in the upper and lower ends of the reaction container 180, and the pressing plates 150 and 160 are put into close contact with the corresponding transparent Teflon films 170. Here, the pressing plate 160 having the pressure relief hole 161 may be coupled to the upper end of the reaction container 180. Subsequently, the lids 130 cover the corresponding pressing plates 160. The lids 130 not only bring the pressing plates 160 into close contact with the reaction container 180 but also come into close contact with the casing 190. After the assembly of the lids 130 has been finished, the covers 110 are threaded over the casing 190, thus completing the assembly of the airtight container 100.

The airtight container 100 in accordance with the first embodiment of the present invention allows the experimenter to observe a chemical reaction, a thermal reaction, and the like. that is caused in the space 181 of the reaction container 180 with the naked eye. In detail, the space 181 is open on upper and lower ends thereof, and these openings are covered with the transparent Teflon films 170 and the transparent pressing plates 150 and 160. The transparent Teflon films 170 and the pressing plates 150 and 160 are exposed to the outside through the lid holes 131 and the observation holes 111. Thus, the experimenter can observe in real time the chemical reaction in the space 181 through either observation hole 111. Therefore, the airtight container 100 of the present invention is very useful in conducting real experiments.

Furthermore, the reaction container 180 and the transparent Teflon films 170 which make direct contact with the sample are made of Teflon material that is insoluble in all solvents. Hence, the airtight container 100 can be safely used even in an experiment involving a high acid, such as hydrofluoric acid or the like, that can dissolve glass.

Although the transparent Teflon films 170 that are comparatively thin are used for the airtight container 100, they can reliably cope with an increase in the pressure in the reaction container 180, because the pressing plates 150 and 160 that are supported by the lids 130 and the covers 110 function to support the transparent Teflon films 170.

Moreover, the pressure relief hole 161 is formed in at least either one of the pressure plates 150 and 160, whereby even if the pressure in the reaction container 180 abnormally increases, gas can be discharged out of the reaction container 180 through the pressure relief hole 161 after tearing the corresponding transparent Teflon film 170. This allows the experiment to be even more safely carried out.

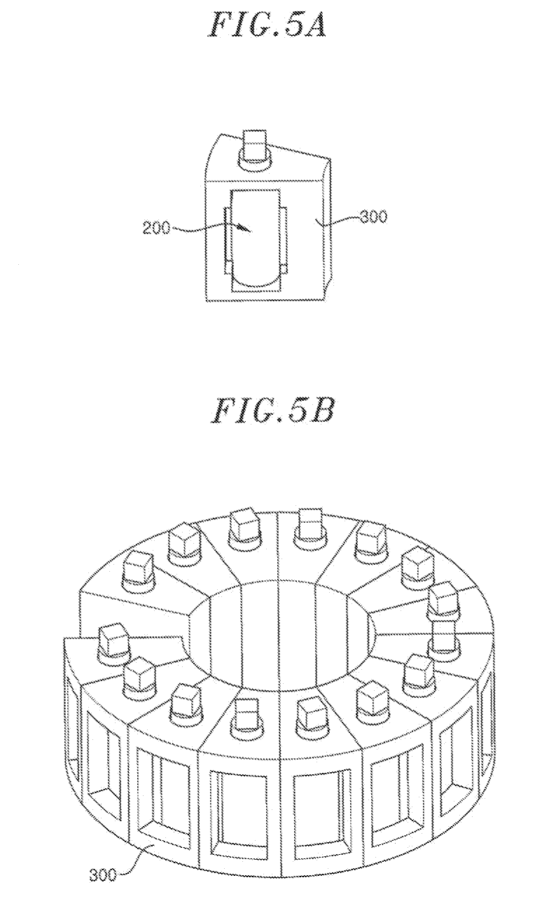

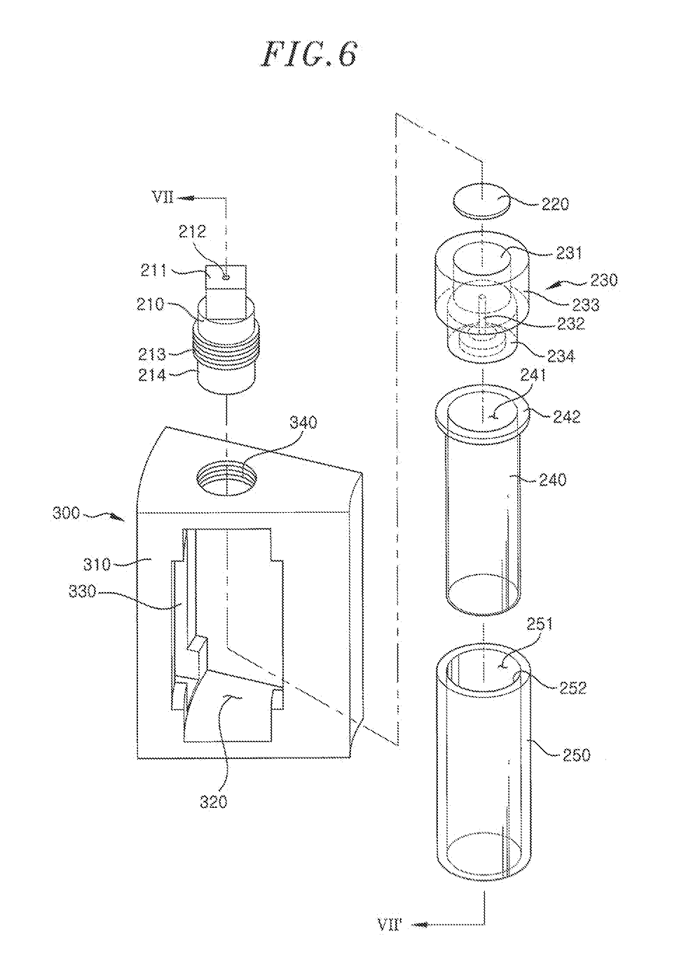

Hereinafter, an airtight container in accordance with a second embodiment of the present invention will be described with reference to FIGS. 5A to 7.

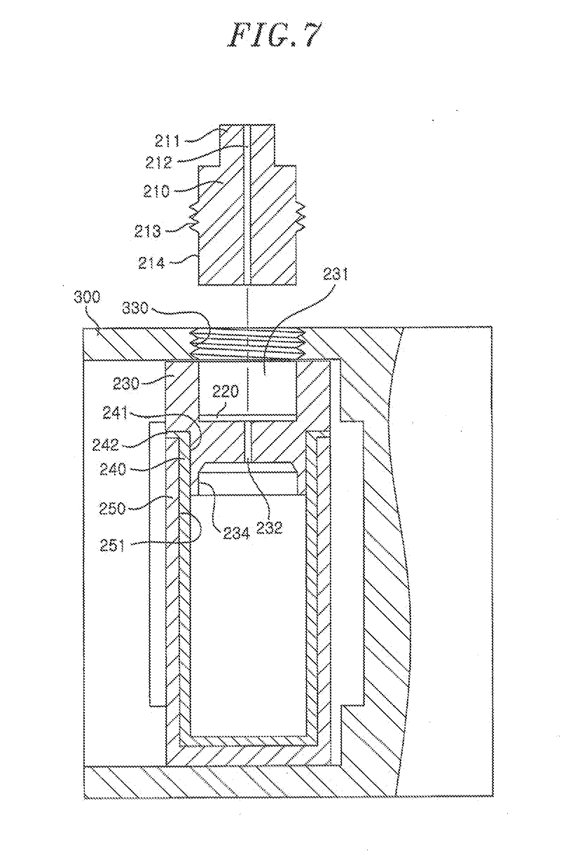

FIGS. 5A and 5B are perspective views showing an experimental instrument provided with an airtight container in accordance with the second embodiment of the present invention, and an example diagram which a plurality of experimental instruments are connected each other into a single body, respectively. FIG. 6 is an exploded perspective view of FIG. 5A. FIG. 7 is a cross sectional view taken along the line VII-VII′ of FIG. 6.

The airtight container 200 in accordance with the second embodiment of the present invention can be installed in an experimental instrument 300 which can be loaded in a microwave oven, a typical heater or the like.

As shown in FIG. 5A, the experimental instrument 300 has a receiving space 320 in which the airtight container 200 is contained. Further, as shown in FIG. 5B, a plurality of experimental instruments 300 may be connected to each other into a single body, before they are loaded in a microwave oven or the like.

The experimental instrument 300 includes a housing 310 which defines the receiving space 320, an opening 330 which is formed in the housing 310 to allow the experimenter to observe the airtight container 200 loaded in the receiving space 320, and a cover coupling hole 340 which is formed in the upper end of the housing 310 so that a cover 210 of the airtight container 200 which will be explained later is fitted into the cover coupling hole 340.

The housing 310 is configured such that it is connected to housings of adjacent experimental instruments. The size and shape of the receiving space 320 correspond to those of the airtight container 200. The opening 330 may be formed in each of the front, rear and outer side surfaces of the housing 310. An internal thread is formed in the cover coupling hole 340 so that the cover 210 can be threadedly coupled to the housing 310.

The airtight container 200 includes a reaction container 240 which is made of transparent Teflon and receives a sample therein, a casing 250 which encloses and supports the reaction container 240, a lid 230 which is fitted into an opening of the reaction container 240, a Teflon film 220 which is inserted into the lid 230 and closes the opening of the reaction container 240, and a cover 210 which brings the Teflon film 220 into close contact with the lid 230.

The reaction container 240 is preferably transparent to allow the experimenter to observe the inside of the reaction container 240 through the opening 330 from the outside of the experimental instrument 300. The reaction container 240 may be made of Teflon so that it can be used even in an experiment in which a sample is strong acid, such as nitric acid, hydrochloric acid, sulfuric acid, hydrofluoric acid, phosphoric acid, and the like. The reaction container 180 may be opaque. For instance, the reaction container 240 may be made of a transparent Teflon film.

The reaction container 240 has a sample receiving space 241 into which the sample is input and which is open on the upper end thereof, and a flange 242 which is provided around the sample receiving space 241.

The sample receiving space 241 corresponds to the space 181 of the first embodiment, and the flange 242 corresponds to the flange 183 of the first embodiment.

The reaction container 240 is inserted into the casing 250. The casing 250 is made of transparent glass, quartz, Pyrex, and the like. to allow the experimenter to observe the inside of the reaction container 240. The casing 250 has a container receiving space 251 which is open on the upper end thereof to enable the reaction container 240 to be inserted into the container receiving space 251 through the open upper end thereof, and a flange seating portion 252 which defines the mouth of the container receiving space 251 and onto which the flange 242 is placed.

The casing 250 is cylindrical and is configured such that it can be loaded into the receiving space 320 of the experimental instrument 300. The diameter of the container receiving space 251 corresponds to the outer diameter of the reaction container 240 so that the circumferential outer surface of the reaction container 240 that is inserted into the container receiving space 251 is put into close contact with the circumferential inner surface of the container receiving space 251. Thereby, even if the pressure in the reaction container 240 increases, the reaction container 240 can be safely supported by the casing 250.

The container receiving space 251 corresponds to the reaction container hole 191 of the first embodiment 191. The flange seating portion 252 corresponds to the seating portion 192 of the first embodiment.

The lid 230 is fitted into the sample receiving space 241. The lid 230 includes a lower unit 234 which is fitted into the sample receiving space 241, an upper unit 233 which is placed onto the flange 242, a film receiving portion 231 which is formed in the upper end of the upper unit 233 and receives the Teflon film 220 therein, and a hole 232 which communicates the film receiving portion 231 with the sample receiving space 241.

A portion of the lower end of the cover 210 is inserted into the film receiving portion 231. The Teflon film 220 can be put into close contact with the bottom of the film receiving portion 231 by a pressing part 214 of the cover 210 that will be explained later herein.

The lid 230, especially, the lower unit 234, is made of Teflon, because it may make direct contact with the sample.

The cover 210 has the pressing part 214, an external thread 213, a grip 211 and a pressure relief hole 212. The pressing part 214 is inserted into the film receiving portion 231. The external thread 213 is formed in the upper end of the pressing part 214 and engages with the internal thread formed in the cover coupling hole 340. The grip 211 is disposed above the external thread 213 so that the experimenter can grasp the grip 211 and rotate the cover 210. The pressure relief hole 212 is formed through from the pressing part 214 to the grip 211.

The cover 210 is assembled with the housing 310 after the Teflon film 220, the lid 230, the reaction container 240 and the casing 250 have been assembled together and loaded into the receiving space 330 of the experimental instrument 300.

In detail, the casing 250 that has been assembled with the Teflon film 220 and the other elements is located in the receiving space 330 such that the film receiving portion 231 is disposed just below the cover coupling hole 340. The cover 210 is inserted into the cover coupling hole 340. Thereafter, the experimenter grasps the grip 211 and rotates the cover 210, whereby the cover 210 can be moved downwards so that the pressing part 214 can bring the Teflon film 220 into close contact with the bottom of the film receiving portion 231.

In the airtight container 200 in accordance with the second embodiment of the present invention having the above-mentioned construction, the reaction container 240 and the casing 250 are made of transparent material, allowing the experimenter to observe the status of the sample in the reaction container 240 through the opening 330 of the housing 300.

Furthermore, although the material of the reaction container 240 is a transparent Teflon film that is a comparatively thin, it can reliably cope with an increase in the pressure in the reaction container 240, because the casing 250 provides support to the reaction container 240.

Moreover, the pressure relief hole 212 is formed in the cover 210, whereby even if the pressure in the reaction container 240 abnormally increases, gas can be discharged out of the reaction container 240 through the pressure relief hole 212 after tearing the Teflon film 220. This allows the experiment to be even more safely carried out.

While the embodiments of the airtight container for experiments in accordance with the present invention have been shown and described for illustrative purposes, it will be understood by those skilled in the art that the scope of the present invention must be construed as being the widest that can be derived from the spirit and scope disclosed in the specification rather than being limited to the embodiments. Further, those skilled in the art will appreciate that undescribed types of patterns can be embodied by a combination or substitution of the described embodiments of and element, and that various modifications are possible on the basis of the specification, and it is apparent that these combinations, substitutions and modifications also fall within the bounds of the present invention.

While the invention has been shown and described with respect to the embodiments, the present invention is not limited thereto. It will be understood by those skilled in the art that various changes and modifications may be made without departing from the scope of the invention as defined in the following claims.

1. An airtight container for a reaction experiment, comprising:
a reaction container made of Teflon, the reaction container having an opening in at least a portion thereof;
a casing configured to support and enclose a circumferential outer surface of the reaction container;
a Teflon film configured to close the opening of the reaction container;
a pressing part configured to be disposed on the Teflon film and press the Teflon film toward the reaction container such that the Teflon film makes close contact with the reaction container; and
a cover configured to be disposed on the pressing part and apply a force to the pressing part so that the Teflon film is pressed toward the reaction container and kept in close contact with the reaction container,
wherein an observation hole is formed through the cover, and the Teflon film and the pressing part are exposed to the outside through the observation hole, and wherein the Teflon film is transparent and the pressing part is made of a transparent material.

2. The airtight container of claim 1, wherein holes are respectively formed in the pressing part and the cover so that when the Teflon film is torn, gas is discharged out of the reaction container through the holes.

3. The airtight container of claim 1, wherein the Teflon film includes a transparent Teflon film, and the pressing part is made of one of glass, quartz and Pyrex.

4. The airtight container of claim 3, wherein the observation hole is formed in the cover at a position corresponding to the pressing part and the Teflon film.

5. The airtight container of claim 3, further comprising a lid disposed between the pressing part and cover, and having a lid hole formed therethrough, and
wherein the cover presses the lid such that the lid presses the pressing part toward the reaction container, and
the lid is brought into close contact with the casing by the cover.

6. The airtight container of claim 4, further comprising a lid disposed between the pressing part and the cover, and having a lid hole formed therethrough, and
wherein the cover presses the lid such that the lid presses the pressing part toward the reaction container, and
the lid is brought into close contact with the casing by the cover.

7. The airtight container of claim 1, wherein the reaction container is made of a transparent Teflon film, and
the casing is made of one of glass, quartz and Pyrex.

8. The airtight container of claim 1, wherein the cover is threadedly coupled to the casing.

9. The airtight container of claim 1, wherein the pressing part has a shape of a convex lens.

10. The airtight container of claim 1, wherein the lid has a pressing part seating portion depressed in the lid to a predetermined depth into a shape corresponding to that of the pressing part.
